(19) United States
(12) Patent Application Publication
(10) Pub. No.: US 2019/0164245 A1
(43) Pub. Date: May 30, 2019

(54) METHOD FOR AUTOMATICALLY LINKING ASSOCIATED INCIDENTS RELATED TO CRIMINAL ACTIVITY

(71) Applicant: Detective Analytics LLC, Toms River, NJ (US)

(72) Inventor: Dean TAKACS, Edison, NJ (US)

(73) Assignee: Detective Analytics LLC, Toms River, NJ (US)

(21) Appl. No.: 16/205,104

(22) Filed: Nov. 29, 2018

Related U.S. Application Data
(60) Provisional application No. 62/591,854, filed on Nov. 29, 2017.

(51) Int. Cl. G06Q 50/26; G06F 16/35; G06Q 30/02; G06N 20/00

(52) U.S. Cl. CPC G06Q 50/26; G06N 20/00; G06Q 30/0205; G06F 16/353

(57) ABSTRACT

A method for automatically linking associated incidents related to criminal activity is disclosed. A system for processing the method is also disclosed. The method operates by scraping text from a number of incident reports. The scraped text is then analyzed to determine the present of one or more unique IDs, which are used to calculate similarity between each incident report. The system employs machine-learning to better identify these pairs in the future, and optionally with the assistance of a human user providing a feedback loop to enhance the machine-learning.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### CLAIM OF PRIORITY

This application claims priority to U.S. Provisional Patent Application No. 62/591,854, filed on Nov. 29, 2017, entitled “Method for Automatically Linking Associated Incidents Related to Criminal Activity,” the contents of which are hereby incorporated by reference in their entirety.

### FIELD OF THE EMBODIMENTS

The present disclosure relates generally to a method for automatically linking associated incidents related to criminal activity. More particularly, the present disclosure relates to a method of scraping data from criminal activity reports, categorizing the data, and then using machine-learning to predictively and automatically link related events.

### BACKGROUND

Both law enforcement and retail companies create incident reports each time suspicious or illegal activity has taken place. Whether it's incident reports pertaining to the activity that occurs within a branch of a retail store, or a police report disclosing more general criminal activity, thousands, if not millions of these reports are generated each year. However, due to the sheer volume of reports that get generated, many of the reports go unread or are not analyzed. This is frequently because of lack of manpower, which often yields lack of return-on-investment, for the companies to thoroughly go through these reports to see if any valuable information can be extrapolated.

In terms of retails companies, theft represent a sizable portion of losses such, it would be beneficial if linking incidents of theft was simple enough to render a proper return-on-investment. As it turns out, one might expect, serial offenders and crime organizations are responsible for a significant portion of these crimes. For this reason, there is a great incentive to stop an entity that is likely to continue committing crimes if left unchecked. However, given the time intensive nature of going through the massive amount of incident reports attempting to link them, it is simply not feasible for companies to assign human personnel to go through everything.

As such, there is a need for a system that allows companies and law enforcement to link related crimes based on information contained in the respective incident reports, such that knowledge of the linked incidents may prevent future related incidents. Further, such a system would be able to determine the presence of a repeat criminal offender or offenders, in addition to being able to uncover large groups of people coordinating efforts to perpetrate crimes. Moreover, such a system would make it easy to assemble evidence to turn over to law enforcement, or to be used by prosecutors to help supplement a case.

### SUMMARY

The present disclosure provides for a method for automatically linking related incidents related to criminal activity. In one embodiment, the method begins by receiving at least two incident reports from a database, where each incident report contains a portion of raw text, a time indicator, and a location indicator, where the portion of raw text contains information that relates to at least one item of information pertaining to a criminal event. The method then continues to apply, at least one set of rules to the portion of raw text, where each set of rules is configured to determine whether one or more unique IDs is located in the portion of raw text from each of the at least two incident reports. Then the presence of one or more unique IDs in any of the at least two incident reports is determined through the application of the at least one set of rules to the portion of raw text. A vector is then generated for each of the pairs of incident reports, where the vector has a plurality of dimensions comparing the incident reports. One or more machine-learning algorithms are applied to the vectors to determine a pairwise probability between each of the at least two incident reports. The system, by performing the method, then automatically links related incident reports when the pairwise probability is above a predetermined threshold amount.

In some embodiments, the pairwise probability of any known links between the at least two incident reports is set to 1 and in other embodiments the raw text contains both the time indicator and the location indicator. Many unique IDs are capable of being identified by the present invention. Such unique IDs include full name, physical characteristics, ethnicity, license plate, driver's license number, address, credit card number, unique customer ID, customer loyalty number, fingerprint, retinal scan, face map, unique physical gait map, keyboard and mouse usage map, DNA, customer gift registry, social security number, email address, phone number, IP address, and incident number. The dimensions of each vector can be calculated from the following variables: a time distance, a time-of-day difference, a geographic distance, a cosine similarity of the portion of raw text of the at least two incident reports, a gender description similarity, a ethnicity description similarity, an eye color description similarity, a hair color description similarity, a weekend indicator similarity, a height description similarity, a multiple suspect indicator, a weight description similarity, a vehicle description similarity, a maximum text quality score, a minimum text quality score, and an age description similarity between two incident reports. Note that the text quality score is generated from a separate machine-learning binary regression model that uses incidents present in quasipositive pairs as positive examples and incidents not present in positive or quasipositive pairs as negative links. The goal being that quasipositive pairs are recognized by a human to be possibly connected and hence both incident texts in a quasipositive pair must have good quality.

In a highly preferred embodiment, the machine-learning algorithm employs a Siamese-trained pair of neural networks to predict links. In some embodiments, the clustering algorithms are either distance-based or density-based algorithms. In some preferred embodiments, a human user may enter a separate pairwise probability for linking two given reports. This human-entered pairwise probability will supersede any calculated pairwise probabilities when used in future processing.

In some embodiments, the system performs a method for determining when a full name is present in an incident report. The system achieves this by first receiving a list of the most common first names in a particular geographic region, a list of the most common last names in said geographic region, and a list containing the most common words in the most prevalent language in said region. Any entries from the list of first names or list of last names that share a commonality with the list containing the most common words will be removed from their respective list. Then, a vector of words is generated based on one of the provided incident reports, where the vector retains the same order of words as listed in the provided incident report. One or more indices that contain entries from the pared-down list of first names is then extracted from the vector; this is also done based on entries from the pared-down list of last names. Whether a first name is followed by a last name is determined next. This is achieved by subtracting one from each entry in one of the indices generated from the pared-down list of last names and comparing it to one of the indices generated form the pared-down list of first names.

In other embodiments, the gender similarity is determined by first generating a linear ordering having a plurality of groups based on one or more genders reported in the provided incident reports. The linear ordering is high to low based on the conditional probability of the likelihood of a positive link between two random incidents, given only the different possible combinations of presence of genders in both pairs. That is, the ordering is based on which possible combinations of gender indicators in a random pair yield the best increase in probability that the pair is related. The gender similarity for a particular pair is then set from the values from this linear ordering.

In some embodiments, a training set is created to be used within the system and method in accordance with the present disclosure to allow for the incident reports to be formally linked via machine-learning. One way of creating such a training set is to provide a number of incident reports where there exist positive links between some of the reports. A maximum threshold is set so that too many positive links are not used for the training. This is unlikely to be necessary in practice, however, it is still beneficial to utilize the threshold. An amount of the positive links are then sampled, where the amount is equal to or less than the threshold. A number of quasipositive links are provided and sampled, where the amount sampled are related to a second, separate predetermined threshold. A number of negative links are then sampled by the following method. A sample with replacement is taken from the vector of incident IDs to generate two vectors, each vector having a length that is equal to 10 times the amount of positive links sampled earlier. These two vectors are then combined into a table having two columns, where each column has some value in it. Any rows where the value is the same in each column are dropped, as a link cannot be from the same incident to itself. In addition, any rows in which the pair of incidents are already in the set of either the positive or quasipositive links are dropped. The sampled positive links, the sampled quasipositive links, and the sampled negative links are combined into a table which contains a column showing the probability of a link being valid within a given value. Here the probabilities of positive links set to substantially 1, the probabilities of negative links set to substantially 0, and the probabilities of the quasipositive links set to the user assigned probabilities specific to each pair in the quasipositive links. Finally, a distance variable is computed for each of the links and each of the distance variables within the table.

An alternate method of creating a training set for a machine-learning-enabled computer to process the set is also contemplated. The method starts by providing a number of quasipositive links between two of the incident reports and subsequently setting a first maximum threshold of an amount of quasipositive links that will be used for training. The method then samples the amount of quasipositive links, where the amount is equal or less than the first maximum threshold. From that sampling the method generates a number of negative examples by randomly sampling two incidents from the at least two incident reports such that the randomly sampled incidents are individually present as a single element in the pair of at least one of the quasipositive links, but any randomly sampled pair is not amongst the quasipositive links.

The present disclosure also provides for detecting similarity scores based on combinations of observed discrete states between pairs of incidents. It begins by providing, a preselected list of a plurality of observed discrete states and then scraping the plurality of incident reports for words or phrases that relate to each of the plurality of observed discrete states. This step can also be performed by training a machine-learning model to detect the plurality of observed discrete states. A binary indicator variable is then created for each of the plurality of observed discrete states in each of the plurality of incident reports if the discrete state is detected. A count for each of the plurality of observed discrete states is stored, where the count corresponds to a sum of the total incidents of that detected observed state. A first vector comprised of conditional probabilities of true state for each of the plurality of observed discrete states is produced, and then a second vector comprised of count-adjusted conditional probabilities, where the count-adjusted conditional probabilities are created by adjusting the magnitude of the first vector, representing the conditional probability of the true states, inversely proportional to the observed total count, summed from all incidents of the observed discrete state is also produced. After that, a scoring vector is created, where the scoring vector is equal to the element-wise sum of all the second vectors from all of the observed discrete states, if more than one discrete state is observed, else if one discrete state is observed the scoring vector is equal to the second vector, for a given incident. A reduced scoring vector is subsequently created by multiplying the scoring vector by a constant reduction factor set between 1 and the inverse of the total discrete states detected in the given incident. Finally, a similarity score between two of the plurality of incident reports by computing the inner product of the reduced scoring vectors associated with the two incident reports. Embodiments exist where the plurality of observed discrete states is based on the ethnicities prevalent in a selected geographical region. When no discrete states are detected in either of the two incidents, a default similarity score is assigned.

The present disclosure also provides for a method of creating synthetic positive links for use in a training set for machine-learning. Prior to creating synthetic positive links, a training set consisting of all the non-synthetic links must already be created. First, an amount of synthetic positive links to be created is selected. Then, a synthetic subset of the training dataset having a plurality of rows of data is created, and a vector for a plurality of distance variables; where the length of each vectors corresponds to the plurality of rows of data is also created. The plurality of distance variables is then synthetically populated by selecting a random value equivalent to a percentile from a random distribution. The random distribution must be within the range of 0 to 1, and the probability density must be monotonically decreasing within that range. The monotonically decreasing distribution samples more often values near 0, corresponding to small distances, which would be expected in similar, and hence linked, pairs. Then, a percentile is converted to an actual distance value by extracting the random percentile sampled values from the distribution of all the values for that particular distance variable that is in the non-synthetic link training set that already exists. A synthetic pair is then created, which gets subsequently added as a positive link to the training set. In the event that a similarity variable is used instead of a distance variable, then instead of a percentile value, one may also select 1 minus the percentile value from one of the plurality of vectors. This samples more often values near 1, corresponding to high similarities, which would be expected in similar, and hence linked, pairs.

Yet another aspect of the invention is a human-AI combined interactive method for pairwise similarity learning. First a plurality of highly likely predicted pairs of incidents, which is only a small subset of all possible pairs, is provided to the human user, where each predicted pair has a first probability. From there, a human user has the option to assign a second probability to each predicted pair. When a pair is assigned a second probability, updating the probability to be equal to the second probability. Preferably, the second probability is determined by the human user's intuition.

Yet another aspect of the human-AI combined interactive method, is a method for filtering highly likely pairs to those which might contain significant circumstantial evidence. Preferably, prior to viewing the top likely pairs, and deciding whether or not to assign a second probability, the user can choose to filter the top likely pairs to only those which might contain significant circumstantial evidence. A topic is chosen which might provide such significant circumstantial evidence, such as: vehicle detected, scars detected, tattoos detected, piercings detected, electronic model/device detected, and specific ethnicity detected. The user can choose to apply a filter for one or more of these topics. The highly likely pairs will then be filtered in such a way that every pair must have this topic detected in both incidents in the pair. This allows the user to use human intuition to determine if the pair seems to share a common description of potentially significant circumstantial evidence. This then allows the user to assign very high second probabilities for those pairs. For example, if a “scars detected” filter is applied, the user will view only those pairs for which each incident contained indications that a suspect had scars. If a suspect in one element of the pair is described as having a scar from his left eye to his left ear, and a suspect in the other element of the pair is described as having a scar from his left eye to his left ear as well, this can drastically increase the probability that they are related.

Yet another aspect of this system/this method, is a meter that is set by the human user, where the meter is in the range of 0% to 100%. For any desired selection of the meter value, at least one group containing at least two predicted pairs having a probability that is higher than the meter is subsequently formed. If set at 0%, all incidents would belong to a single group. If set at 100%, only known links will be grouped together.

In yet another set of embodiments, the group extraction process by linking pairs is performed in broader strokes. First, as much information as possible is extracted from one or more incident reports. Such information includes suspect(s) description, modus operandi, behavior, and target. From there, supervised machine-learning is employed to learn one “main” and a few “variable-omitted” probability predictions between all possible pairs of incidents. The purpose of “variable-omitted” probability predictions is to detect links that exist across vast distances. For instance, some criminal networks may operate thousands of miles apart, omitting geographic distance will allow us to detect these links which would have otherwise been assigned a very low probability. Another example is some criminals might strike in very long intervals, so omitting time distance would help detect these links. Only a subset of the pairs will be saved, depending on the likelihood of the prediction.

Preferably, incidents are grouped together in one of two main ways. One such way is to cluster nearby incidents together using a distance matrix that was created from the incident pairs that were predicted with the highest prediction of likelihood of being linked, including all positive links. This can be achieved through clustering algorithms such as DBSCAN or hierarchical clustering. One highly preferred embodiment employs a combination of DBSCAN and hierarchical clustering, where DBSCAN is used to create the first cluster of groups, and for clusters that have sizes above a given threshold, hierarchical clustering is then applied with the precise height level that breaks that cluster so that the largest size of the broken sub-clusters are less than the max cluster size.

Generally, the various embodiments of the present invention employ three different schemes to form groups: (1) Active AI-Assisted Single Group Building, (2) Multi-group forming via human pair second probability assignment, and (3) Non-active supervised machine-learning. Note that for each of these different schemes, linking based on unique IDs is implicitly done.

Generally, the Active AI-Assisted Single Group Building operates by a computer presenting a human user with incident nodes from an amount of highly likely pairs where for each link, one and only one, of the incident nodes in the link is already in the current group. To begin, a human user must select one or more incidents as a starting point for the group building. From there the human user manually searches and evaluates through the top n recommended incident nodes. If the user finds what they intuitively evaluate as a “highly likely” linked incident node out of the top links presented, the additional incident node is added to the group and the process is repeated. If not, this process ends.

The multi-group forming via human pair second probability assignment begins by presenting the human user with a list of the top pairs chosen by highest available probability score. The human user manually goes through as many pairs as possible and assigns second probabilities, based on human intuition, to pairs as desired. The user can then set a desired probability threshold, above which any pair will be used as links for grouping. The incidents are then automatically grouped by creating connected subgraphs from all of the incident nodes that are connected from the pairs meeting the threshold, together with the known positive links.

Lastly, non-active supervised machine-learning operates by utilizing AI Automatic Grouping. That is, the algorithm takes the list of top predicted pairs as links, along with known links, and clusters from these links.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

Implementations may include one or a combination of any two or more of the aforementioned features.

These and other aspects, features, implementations, and advantages can be expressed as methods, apparatuses, systems, components, program products, business methods, and means or steps for performing functions, or some combination thereof.

Other features, aspects, implementations, and advantages will become apparent from the descriptions, the drawings, and the claims.

### DETAILED DESCRIPTION OF THE PREFERRED EMBODIMENTS

The present disclosure contemplates a method for automatically linking, using probabilistic determinations, incident reports containing information on a crime. Preferably, this will be used to help identify serial offenders who take actions to hide the scope of their criminal activities. This method begins with receiving at least two incident reports, and preferably a very large database of reports. One advantage of the method is that it is capable or parsing through large amounts of reports, well beyond what is capable by humans alone. The incident reports preferably have three components: a location indicator, a time indicator, and a raw text writeup of the incident. However, the method also can operate with incident reports that only contain a raw text writeup. To pull unique IDs from the raw text, the method applies at least one set of rules to the raw text. Preferably, each set of rules is tailored to determine the existence of a specific type of unique ID.

In various embodiments, the unique IDs are grabbed from an incident report, from one or more delineated data fields themselves. Then each potential unique ID is extracted from the raw text. While performing both of these steps may seem strange at first blush, a simple example will show how their use creates a robust set of rules: in a given incident report there may be a dedicated data field named “Suspect License Plate” which captures license plates, however, not all authors of the incident reports are diligent in using said field may insteadwrite this information in the raw text. Other examples exist that highlight the utility of this dual-stepped set of rules as well.

When these IDs are present in their delineated data field, it is known that they are actual suspect IDs. However, when the IDs are extracted from the raw text, it cannot be determined whether they are actual suspect IDs (for instance a manager's name or a store's phone number) so a human must verify them as being an actual suspect ID. Machine-learning is also used to try to predict if an extracted suspect ID is likely a positive suspect ID. If the probability is above a certain high threshold, the ID is automatically classified as a positive suspect ID. Note that for each ID type except for suspect name, regex expressions or deep learning for named entity detection are employed to extract the ID.

However, for extracting suspect names, the following can be performed: get a list of the top several-thousand most common first names in a desired geographical region, get a list of the top several-thousand most common last names in said geographical region, and drop all names from both lists that overlap or partially overlap with the top few-thousand most common words in the most prevalent language in said region. By removing names that have overlap with common words, the chances that names will be falsely detected from the text is greatly reduced.

For each incident report or incident write-up, all of the words found in the raw text must be split up into a vector of words that retains the same order as the incident report or write-up. From there, all of the indicies that contains words from the list of first names are extracted from the vector. This is also done for the vector that contains words form the list of last names. Once these indicies are extracted, one is substracted from the index created from the list of last names and is compared against the index generated from the list of last names. This detects the presence of a first name immediately followed by the last name. When a full name is detected, it is captured and all incidents that contain that full name are associated with the other reports containing that full name.

Regarding the various unique IDs present in each of the provided incident reports, unique IDs can be obtained from both provided data fields as well as from the raw text. For the purposes of this disclosure, data fields are columns that are specific to incident write-ups, containing specific types of information. Preferably, the system provides for a table where each type of unique ID is given a row. This table also shows whether the unique ID was detected, the amount of times it was detected, whether or not the ID was verified by a human user, and whether it has been positively or negatively associated with an incident report.

If a unique ID is present at least once in an actual data field (as opposed to the raw text), it is considered to be verified positive. When an ID was not present in at least one actual data field, has not yet been verified by a human user, or the system was unable to predict with sufficient certainty that the unique ID a positive suspect ID, the system then provides for a means for the human user to explicitly verify the ID. Once an ID is verified, all existing and future incidents containing that ID will be classified accordingly. Verification is not permanent and can be changed by the human user, if necessary.

In short, in one embodiment of the system and its method of use, unique IDs are automatically extracted and subsequently verified by a human user as to whether or not the ID is a positive suspect ID or negative suspect ID. The verified positive IDs then are used to both create absolute links and which are used by the system to learn to link incident reports that contain those links better in the future.

Often it is important to map different IDs to a common ID, as frequently in incident reports two “different” IDs actually refer to the same ID. One instance of this occurs due to misspellings such as with addresses that are spelled slightly differently, or where an apartment or suite number is omitted from the write-up. Another instance of this is when a nickname is used as opposed to a suspect's full name. To address situations like this, string edit distance similarities are employed to detect when two different IDs may actually refer to the same ID. One way in which this is achieved is to have the system identify these potential conflicts and to have a human user choose a “dominant” ID to which the other potentially related ID(s) are mapped. For example, “Bob Johnson” would be mapped to “Robert Johnson.” All incidents containing IDs that are mapped to the same name will then be positively linked.

In very rare cases, incident reports that contain the same ID will actually refer to two different people. An example would be instructive as to how to address this. In this hypothetical instance, a Connor Johnson from New Jersey and a Connor Johnson from Louisiana both were detected in two different incident reports. To detect this, the system utilizes unsupervised machine-learning to see if the incidents belong to one large cluster or to two distinct clusters. If the clusters are distinct enough, the system will warn the user of the potential duplicate. Once identified, the user can then verify if they are truly different, and if so, the user will be able to “split up” the ID into two different mapped names. With the two differently mapped names, the system will then predict which of the two or more groups each shared ID belongs to, and prompt the user to verify these predictions.

To calculate pairwise similarity within the present system, a plurality of distance and similarity variables are used. Such variables, also known as dimensions, include: time distance (in days), represented by the absolute values of the date difference; time of day difference, represented by the absolute values of the difference in the hour of the day in which each incident occurred; geographic distance, cosine similarity between two incident write-ups; a measure of gender similarity; a measure of ethnicity similarity; a measure of vehicle model similarity; a measure of eye color similarity; a measure of hair color similarity; a weekend indicator similarity; physical measurement similarity; height similarity; weight similarity; a maximum text quality score, a minimum text quality score, and age similarity. For the purposes of this disclosure, a maximum text quality score and minimum text quality score for a given pair of incidents offers the ability of regularizing high cosine-similarity resulting from similar but irrelevant pairs of texts. This text quality score is generated from a separate machine-learning binary regression model that uses incidents present in quasipositive pairs as positive examples and incidents not present in positive or quasipositive pairs as negative examples. The goal being that quasipositive pairs are recognized by a human to be possibly connected and hence both incident texts in a quasipositive pair must have good quality. By “good quality” it is meant that the description present in the incident text was rich enough to allow a human user to recognize that it is likely linked to another incident, which would have also had sufficiently good quality. Note that by “quasipositive” pairs, it is meant that pairs that are identified by a human user as being likely linked, using the human user's intuition.

Generally, cosine similarity gives a 0-to-1 “similarity score” between the raw text of incident reports, depending on how many words in each raw text overlap. For purposes of the present disclosure, two alterations are made to the standard cosine similarity calculation. The first is that after the incident reports are scanned for themes and features such as: whether or not the suspect has facial hair; tattoos; scars; is balding; has piercings; whether credit cards are involved; whether gift cards are involved; whether counterfeit money is involved; and/or whether the suspect is armed. These feature names are added directly into the text before cosine similarity is calculated. For example, if any form of facial hair is detected by the system (e.g., “moustache,” “goatee,” “beard”) the term “hasfacialhair” (or some other equivalent identifier) is added to each write-up before calculating cosine. If a suspect's last name is “Jones,” the system adds “lastnamejones” to each write-up to help increase similarity to help uncover family networks. This increases cosine similarity when this type of identifier is present in both write-ups. In many embodiments, cosine similarity is replaced with a pair of neural networks which are Siamese-trained, very similar to a Siamese LSTM-type system trained to recognize duplicate texts, but with the additional ability to learn relevant concepts and recognize similarity amongst detected concepts in the pairs, such as vehicle description and suspect description. Preferably, this pair of neural networks learns words and phrases that are relevant to crime linking and are capable of computing the similarities between these words and phrases to offer improved incident linking above what pure cosine similarity can offer.

Determining gender similarity between write-ups is handled differently, by utilizing a special set of rules. For each incident write-up it is possible to determine whether or not there is a male suspect and/or a female suspect. So, for each incident there are two binary variables: evidence_male and evidence_female. Consequently, each incident can have 4 possible combinations for both variables. This results in seven discrete groups that a pair of incident reports can fall into:

| Group | Description |
|---|---|
| A | Both reports contain male and |
| | female |
| B | Both reports contain female |
| | only |
| C | Both reports contain male only |
| D | One report contains both |
| | genders, one report contains |
| | female only |
| E | One report contains both |
| | genders, one report contains |
| | male only |
| F | At least one report has no |
| | evidence |
| G | One report contains male only, |
| | the other report contains |
| | female only |

This presents a linear ordering from A-G whereof a scoring with A being the highest chance of the incidents being linked, with G being the lowest. Note that this table assumes that there are more males detected overall than females. If the converse is true, then B and C would swap places and D and E would swap places.

Now that the linear ordering has been established, it is important to address how to “space the scale” between A and G. This starts by obtaining the total counts across all incident reports for both “evidence_male” and “evidence_female”. To address the risk of overfitting, it is important to set a prior count for each. For example, set a prior_gender_count equal to some number, say 100 and then you redefine num_female as (num_female+100) and num_male as (num_male+100).

With the overfitting being accounted for, each group is given a score as follows:

$$\begin{matrix}A & \frac{1}{num\_male} + \frac{1}{num\_female} \\ B & \frac{1}{num\_female} \\ C & \frac{1}{num\_male} \\ D & \frac{1}{\sqrt{2} \times num\_female} \\ E & \frac{1}{\sqrt{2} \times num\_male} \\ F & 0 \\ G & - ( \frac{1}{num\_male} + \frac{1}{num\_female} )\end{matrix}$$

In addition to gender similarity, there are many other similarities that would be helpful to identify. Below is a general methodology for identifying these similarities, as well as some specific use-cases. To determine a similarity measure between two potentially, but not necessarily different observed states from a discrete set of n possible states, where the observed state may not be the true state, but where one can assign conditional probabilities of the true state given the observed state. The goal is to create a scoring for each pair of incidents, for each possible combination of observed states detected in the pair where the magnitude of the scoring is proportional to an increase in the likelihood of two different events being related or linked given the combination of observed states detected in the pair. Specifically, a preselected list of a plurality of observed discrete states would first be provided. Then relevant incident reports would be scraped for words or phrases that relate to each of the plurality of observed discrete states. For each observed discrete state within each incident, a binary indicator variable will be created, initialized to 0, and switched to 1 when that observed discrete state is detected. Each time one of these discrete states is detected, a number is added to an overall count, where the count corresponds to the count of all incidents where that particular discrete state was detected. A vector of conditional probabilities of true state is created, based on all available prior knowledge and evidence including human intuition, for each of the plurality of observed discrete states. The “true state” is the actual state, but the observer may incorrectly classify the state and hence report a different state other than the “true state”. The vector of conditional probabilities is derived from the likelihood of an observer misclassifying the observed state. A second vector is then produced, where this second vector is constructed from count-adjusted conditional probabilities, which are created by adjusting the magnitude of the first vector, representing the conditional probability of the true states, inversely proportional to the observed total count, summed from all incidents of the observed discrete state. From these second vectors, a scoring vector is created, which is equal to the element-wise sum of the second vectors. If more than one discrete state was observed, however, one discrete state is observed the scoring vector is equal to the second vector. A reduced scoring vector is then created by multiplying the scoring vector by a constant reduction factor set between one and the inverse of the total discrete states detected in that incident. For our purposes the constant reduction factor is chosen to be one divided by the square root of the count of distinct discrete states detected in that incident. The purpose of the reduction constant is to avoid unjustifiably large similarity scores due simply to volume of discrete states detected in one or both incidents in a pair. A similarity score is obtained from this by taking the inner product of the reduced scoring vectors associated with two incident reports. When no discrete states are detected in either of the two incidents, a default similarity score is assigned.

While the general methodology is given above, it is instructive to provide an example of how it is applied. One such example may contain a similarity that can be determined is the ethnic similarity between suspects listed in the incident reports. It is desirable to be able to use the ethnic descriptions of suspects from two different incident reports and use this to increase or decrease the probability that they may be linked. For example, if incident report A had a black suspect and incident report B had a white suspect, then the odds of them being linked decrease with the addition of this information. For another example, if incident report C has a Hispanic suspect, and incident report D has a white suspect, then the odds of them being linked are slightly better than the earlier example, as the likelihood of a true Hispanic suspect being mistakenly observed as white is more likely than a true black suspect being mistakenly observed as white. The ethnicity of a suspect in a single incident report is determined by searching for keywords and phrases from the text. For instance, “Asian,” “Chinese,” and “Korean” all describe a suspect that is most likely Asian. In some embodiments, the suspect's first and last name can be used to infer said suspect's ethnicity. In some embodiments, additional machine-learning models can automatically detect likely ethnicities.

While taking the information about ethnicities and linking them directly is acceptable, it is far superior to utilize census data (or something similar) to draw stronger conclusions. For example, in China, if two incident reports mention that the suspect was Hispanic, this should increase the probability significantly more than if the two incident reports mention that the suspect is Asian. The population in China is predominantly Asian so the likelihood of two different Hispanic people being referred to in the two reports is greatly diminished.

Additionally, the system needs to account for situations where the suspect's ethnicity that the reporting officer described was different than the actual ethnicity. For example, there is a significant probability that a middle-eastern person could be mistaken to be Hispanic. As such, it is desirable to treat each observed ethnicity as a vector of the probability of the suspect's actual ethnicity for each of the ethnicities conditioned upon a human detecting some ethnicity. For example, a Caucasian Italian suspect may be described in one incident as Hispanic, but in another the same Italian suspect may be described as Caucasian. Accordingly, when a person is reported as Hispanic, there is a certain probability that that particular person's actual ethnicity is something else. It is then possible to “score” the ethnic similarity between a pair of incidents by calculating the similarities between the conditional probability vectors of each incident's detected ethnicities.

In the case when a pair of incidents that each have only one ethnicity detected and that match, that pair should have a higher score than another pair where each incident report had only one detected incident, which did not match. That is, two incidents where the suspect's ethnicity was reported as Hispanic ethnicity should have a higher ethnicity score than one incident where the suspect's ethnicity was reported as Hispanic ethnicity and one where it was reported as Caucasian.

However, an exception exists to this rule. When there are two proportionally small populations in a given area that resemble each other in physical attributes, it may still make sense to allow a pair with two different ethnicities to have a higher similarity score than a pair with two of the same ethnicities. A crude example is considering Samoan people and Hawaiian people as two different ethnicities. If Samoans make up only 0.01% of the population in a geographic area, and Hawaiians make up only 0.05% of the population in the same area, and say Caucasian people make up the other 99.94%, then the presence of a reported Hawaiian and a reported Samoan in a pair of incidents could provide more evidence than the presence of a reported Caucasian in both incidents. The reason being that the likelihood of mistakenly observing a true Samoan as a Hawaiian, or observing a true Hawaiian as a Samoan is very high. This combined with the likelihood of a pair of crimes having suspects from 0.05% of the population just randomly by pure coincidence is very low.

Applying this reasoning to the general method disclosed above, one must first decide which categories of ethnicities will be used. Based on these choices, a matrix of conditional probability of the actual ethnicity given the reported ethnicity is created. In this matrix each row represents the reported ethnicity and each column represents the probability of the actual ethnicity given that the reported ethnicity was x. Preferably, the conditional probabilities of this matrix should be created based on human intuition of the likelihoods based on the prevalence of various ethnicities within a given population, the likelihood of mistaking one ethnicity for another, and relevant demographic information within a given region.

For each incident, binary indicator variables are created for each chosen ethnicity. For example: Ethnicity_white, Ethnicity_black, Ethncity_hispanic, Ethnicity_asian, and Ethnicity_mideast. Each incident write-up is then scanned for phrases that describe a particular ethnicity, and if so, that binary variable is set to 1. Each suspect name is also optionally used to set the corresponding binary variable to 1. For each type of ethnicity, the totals are also summed and stored.

To avoid overfitting, it is desirable to set a prior count of ethnicities, and add this number to each of the summed totals. From this, adjusted ethnicity counts for each of the selected types are created. Also, to avoid overfitting, a prior matrix to the conditional probability of the actual ethnicity given the reported ethnicity is created. From there, a posterior probability of actual-ethnicity-given-reported-ethnicity is a weighted average between the original matrix and the prior matrix. A relevant equation to determine this posterior matrix is:

Posterior Matrix=(0.9*original)+(0.1*prior)

Next a “vector of counts” is created as the count of incidents in which each ethnicity was detected by summing all binary detections of that particular ethnicity across all incidents. For example, it could have 5 integers where each integer is equal to the counts of white, black, Hispanic, Asian, mid-east ethnicities. A “vector of weighted reported ethnicity” is also required. This is formed by creating a vector for each ethnicity, which is the product of the corresponding row vector from the posterior matrix and the scalar

$$1 / \sqrt[2]{count of observed ethnicity x} .$$

Notice here that the initial row is the probability of the reported ethnicity truly being either of the possible states. And the weighting is from the inverse of the counts, summed up over all binary detections of that particular observed ethnicity across all incidents, of that particular observed ethnicity.

When one of the reports has a suspect with an unknown ethnicity, the average similarity score must be calculated, where that score is the probability weighted average of any of the possible combinations of the ethnicity pairs. This is done by first calculating the inner product of a vector_of_weighted_reported_ethnicity[i] with vector_of_weighted_reported_ethnicity[j] and save it to the matrix of Ethnic Similarity Score, in element i,j. Then the probability-weighted sum is taken from all the elements in this matrix and this becomes a default ethnicity score.

In the case where a certain incident has more than 1 ethnicity detected, the relevant score is calculated by finding the inner product of the sums, of the vectors of count-weighted reported ethnicity for all the ethnicities that were detected in a given incident, divided by the square root of the count of all the different ethnicities that were detected in that particular incident, of the two incidents.

Often, it is beneficial to link incident reports by whether the incidents occurred on a weekend. Criminal entities tend to have preferences related to when they commit offenses. In this instance, for each incident the following weekend scores are used:

### Monday-Thursday→0

### Friday→0.5

### Saturday-Sunday→1

Weekend similarity indicator=1−(2*|Weekend Score_{Incident A}−Weekend Score_{Incident B}|)

After the similarity metrics have been calculated in accordance with the above, the system enforces a priori the scores of different combinations of the potential values of similarities. Machine-learning is then employed to determine how much “proportionately” each similarity measure “adds predictive power”.

To do this, a table of all of the linked pairs is generated. This is done by first using all of our extracted unique IDs to generate linked pairs. For example if license plate HGF432 was involved in 10 crimes, then there will be 10*9/2=45 linked pairs involving all combinations of pairs from these 10. This is done for every unique ID. Also added are the pairs where another incident ID number is mentioned in the write-up of another incident. This means the people writing the incident are claiming that they are linked. Those are added to the table along with the pairs that the user has verified as being related.

It is imperative to create a training set to train machine-learning models for predicting the probability that a pair is linked or not linked. In order to train a binary model, it is imperative to have a training dataset that contains y=1 (linked) and y=0 (not linked). The issue here is that, more likely than not, the number of positive links is several orders of magnitude less than the number of negative links. Typically, there will be a manageably small number of positive links. However, the number of negative links is typically massive. For example, for datasets over ten thousand incidents, there are at least fifty million negative pairs to add to the training model.

As such, a threshold is set for the maximum number of positive links that will be added to the training set. If there are more positive links than the threshold, a threshold amount will be sampled from the links available and are added to the training set.

Negative pairs are defined as the complement of positive pairs from the set of all possible pairs. Note that these are not truly negative, they are effectively unknowns. Of particular interest is the fact that only about ten times the number of positive links for the negative links are needed. To achieve this, two vectors of length ten times the number of positive links that are in the training dataset are randomly sampled with replacement from the entire set of incident IDs. These two vectors are subsequently combined into a table as a pair and any rows where the incidents are the same or when the pair is in the positive links table or quasipositive links table are dropped. These negative links are then also added into the training dataset, which is now complete. For the purposes of the present disclosure, the ranking of the probabilities is more important than the actual probabilities themselves.

In some cases, there will be little or even no positive links for use in the training set. Even in the case where there are a moderate number of positive links, it is beneficial to use synthetic links to help prevent against overfitting. In one embodiment, the method to create synthetic links is as follows: A user must choose the number of synthetic links that are desired to be added. The synthetic subset of the training dataset is then made into a table with x rows of data, and vectors of length x for each distance variable are created from that table. Any random distribution with the property that it is bounded by 0 and 1, and that has a probability density which monotonically decreases from 0 to 1 is then selected. To create a synthetic pair for each of the variables in the synthetic subset of the training set, it must first be considered whether the variable is a distance variable, or a similarity variable.

For distance variables, one sample is taken from the distribution above and that percentile value is selected from the vector of all values of the respective distance variable that is already in the randomly sampled negative pairs from the training dataset. Notice that by nature of the monotonically decreasing density, more values closer to 0 percentile will be selected.

If the variable is a similarity variable, one sample is taken from the distribution above and then 1 minus that sample value is used as the percentile value from the vector of all values of the respective similarity variable that is already in the randomly sampled negative pairs from the training dataset. This process is repeated for the desired number of synthetic pairs and subsequently adds them to the training set as linked pairs.

Once the training set has been created, a method must be performed to train the system to identify links. Preferably, an ensemble of binary regression models that return a probability prediction are employed such as logistic regression, gradient boosting, random forests, naïve Bayes, and Siamese neural networks. Later, all of the

$$N * \frac{( N - 1 )}{2}$$

non-positive links through the prediction model will have to be processed to get the predicted probabilities for each pair. It is only necessary to save the highest predicted values of the unknown links along with the positive links. However, having to process all of the unknown links cannot be avoided.

That said, it is possible to reduce the number of pairs required to calculate predictions. Because it is only necessary to save a very tiny fraction of the top probabilities, it is beneficial to reduce the amount of processing by clustering the incidents beforehand into groups that are the closest.

While a number of approaches to achieve this clustering are suitable, an optimal approach is to use Latent Semantic Analysis (LSA) on the document term matrix of words, to reduce the document term matrix space to a 5 column representation vectors. Then the lat, lng, date, and 5 reduced text columns are combined and then scaled. From there kmeans clustering is performed on this data. This effectively clusters using a weight of 5 to raw text similarity, a weight of 2 to geographic similarity, and a weight of 1 to date similarity, which is a desirable weighting scheme. From here, all that must be predicted are the probabilities of unknown pairs of incidents that lie in the same cluster or in nearby clusters. In some embodiments, one could even only calculate the probabilities for pairs within the same cluster. This would reduce the time required to process the pairwise probabilities to almost

$$\frac{1}{\# of clusters} .$$

However, before all of the pairwise calculations are calculated, to be a bit more thorough it would be preferable to quickly be able to determine which clusters are most likely close together, and which clusters are most likely far apart. It would then be possible to calculate the pairwise predictions for all incidents within the same cluster and for those incidents in different but nearby clusters. This is achieved by randomly sampling pairs from each pairwise combination of clusters. There are

$$\frac{( {c}^{2} - c )}{2}$$

of these pairs of clusters that must be sampled from.

To reduce the number of pairs required to calculate predictions, the system must randomly sample two large vectors of incidents with replacement from the vector of all of the incidents. This can be accomplished by creating a table called “Random Incident Pairs” with these two vectors as columns, and by dropping duplicated rows and rows in which both incidents are the same. These random pairs are then processed through the prediction model and the probabilities are saved to a 3rd column in the table. A fourth column is added where the rank of the pairs are listed. The rank is based on an ordered list of the highest predicted probability down to the lowest predicted probability, with rank 1 corresponding to the highest probability. From there, a matrix is created where the rows and columns are the cluster names which store the counts of the number of pairs from each cluster combination. Another matrix is also created where the rows and columns are the cluster names which store the minimum probability ranking from all the random pairs that happened to be in that cluster.

Further, yet another matrix is created. Here for each pair of clusters(x,y) that are randomly sampled from some n(x,y) incident pairs, the minimum ranking is found first. The goal is to see if the minimum ranking that is obtained is significantly higher than the expectation if all clusters were equally nearby. If a much higher minimum ranking than would be statistically expected based on the assumption of all clusters being equally nearby is found, then that gives evidence that those two clusters (x and y) are much farther apart and can likely be omitted from cross-predictions.

From here, there are two possible options. Option 1 is to create a matrix called “Cluster Combination Random Minimum Rank Ratio.” Here the goal is to get a measure of the difference between the minimum rank for samples from clusters(x,y), and the expectation of the minimum from the “Cluster Combination Minimum Rank Expectation”. For each cluster pair the ratio of the calculated minimum rank over the expected min rank is calculated. Optionally, it is possible to just use the ratio and choose a ratio threshold as a cutoff for dropping cluster combinations from the combinations that must be calculated. Option 2 is to create a matrix called “Cluster Combination Threshold Function Value”. Notice that if the calculated minimum is much less than the expectation of the minimum, the ratio will be less than 1. If the calculated minimum is much greater than the expectation of the minimum, the ratio will be much higher than 1. Therefore, the calculation of cluster pairs where this ratio is much higher than 1 can be omitted.

Further, it is preferable to create a logical function that allows a highery value for low x, and then moves towards some chosen constant multiple of x as y gets larger. A type of function that satisfies this is y=α+β*x. α is set high enough so that very low expectation minimum ranks can have higher multiples of β and still be considered.

For each cluster pair cluster(a,b), one must find the value of β where this cluster pair(a,b) is dropped when

$$β < \frac{y - α}{x} .$$

Therefore, this value is saved in each element of the matrix “Cluster Combination Threshold Function Value.”

If option 1 was chosen, the method then gets a vector of all the off-diagonal elements of the matrix “Cluster Combination Rank Ratio.” If option 2 was chosen, this vector is calculated from the matrix “Cluster Combination Threshold Function Value.” Then the percentile value is chosen for the number of cluster pairs that are desirable to keep. This percentile value would be the threshold cutoff point. All cluster pairs who meet this threshold criteria are kept.

In some embodiments, facial recognition is used to calculate a distance measure between every uploaded picture that is associated to an incident and that has a face detected. The distance matrix is transformed into a table with 3 columns: incident_a; incident_b; and facial_distance. This allows the user to check the most similar pairs of faces and to either flag as likely related, verify that the two faces are not the same, or 100% verify that the faces are the same.

In other embodiments, the system features a “groupings tab” which shows four different types of groupings. The first is absolute groupings, which includes all groups that are generated from all established absolute links such as links created from incidents that share the same ID, incidents which contain written references to other links, or are 100% verified by the user. The second is predicted groupings which are made in one of three ways: (1) probabilistically related incidents that are not absolutely established links; (2) a combination of incidents that are absolutely linked to each other as well as some incidents that are probabilistically related to the others; and (3) composed of only two or more distinct Absolute groupings which are probabilistically related to each other, but where the links between the groupings are not established. The third is flagged likely groupings which deals with those links which a user has previously assigned a second probability to, where the probability is above a current metered threshold set by the user when wanting to view groupings. These groupings are created by grouping from all of the flagged links, and then for any of these groups which happen to contain an incident that is part of an absolutely linked group, all of the incidents from that absolutely linked group are also combined into that group. The fourth grouping is self-flagged likely groupings. This is the same as the previous category except that that only incident reports flagged by the current user are considered.

In some embodiments, the system features an “investigator tool.” A user can import any of the groups, likely links, flagged likely links, or individual incidents into the investigator tool. The investigator tool displays all the information of the current group of incidents in said tool. Of note is that the investigator tool can only contain one group of incidents at the same time. However, it allows the user to save a group and reopen it later. This investigator tool also provides an ordered list of the top recommended incidents that are most likely related to the incidents in the current group of incidents that are in the investigator tool. It does this by finding the most likely probabilistically-related pairs that are not absolutely linked and where one of the pairs is in the current group of incidents that are in the investigator tool. The user can view the information for any of these incidents and can add any of these to the current investigation. The investigator tool gives the option to automatically add absolute links, making it so that when an incident is added to the investigation group that is part of an absolutely linked group, the entirety of the incidents in that absolutely linked group are automatically added to the investigation group.

In some embodiments, the method in accordance with the present disclosure operates to increase efficiency by reducing number of pairs required to predict. It would be great if it was possible to probabilistically eliminate incidents that have a very low likelihood of being present in a linked pair. This can be achieved by labeling each incident as a one if that incident is present in at least one established linked pair, and otherwise is set as a zero. From there, the system employs machine-learning to create a model that gives a probability score of an incident being present in a truly linked pair. A cutoff value of the probability that drops incidents is chosen.

In other embodiments, the system and method provide a list of similar but differently spelled unique IDs. For each unique ID type, the system will process all of the pairwise string similarities, and then save the top n most similar pairs. The user can then verify that the two different IDs actually map to the same ID, and this will link all incidents containing either of the IDs together.

In a series of preferred embodiments, the invention in accordance with the present disclosure is capable of probabilistically linking entities or people to crimes where there is no actual identification of the suspect committing that crime and the person who is probabilistically linked to that crime was not known to have committed any crimes in the past. This is achieved by probabilistically linking together people to other people, and people to crimes and crimes to other crimes, instead of just trying to probabilistically link crimes to other crimes. For example, if there are only 3 people in the entire metropolitan area with a neck tattoo and a missing left hand, and there have been a series of crimes committed by a person with those features, then there is a very high likelihood that each of these 3 people is possibly linked to those crimes. It is then possible to probabilistically link them even if they have never been associated with a crime that was similar, or even to any crime at all.

Further, there exist situations where there are multiple distinct crimes and entities that are inter-related. This is illustrated by the fact that there can be a many-to-many relationship between thieves and fences. A thief may sell his goods to a single fence or to multiple fences. Similarly, a fence may procure stolen goods from a single thief or from multiple thieves. It is usually possible to connect an in-store crime to a thief. but it is also possible to connect a thief to a fence. Also, we might be able to link a fence to an in-store crime (say if very similar products were stolen and wound up being sold by a fence).

This can be achieved through performing the following steps: determining all of the different entities that are to be considered; determining which of the

$$\frac{n * ( n - 1 )}{2}$$

possible relationships are to be used for linking; learning different pairwise similarity prediction models for each type of pair; predicting all possible links; and creating groups from the links based on certain probability thresholds.

The invention in accordance with the present disclosure also teaches a way to increase a similarity score between two incidents when the values being calculated on are highly unlikely to be present. For example, if one incident report says the suspect was 7 feet tall, and another report said the suspect was 7 feel and 1 inch tall, the likelihood of those suspects being the same person is greater given that both heights are far from the average height of humans. Contrast this with another pair of incidents where the suspects in each incident are 5 feet 8 inch and 5 feet 9 inch, respectively. One way in which the similarity score can be increased in this situations is through the following method: creating, a generic similarity score that will give positive scores for measures similar enough and give negative scores for measures different enough; getting all of the values of the particular value-of-interest; calculating the distribution density for that variable over the entire range of variables; applying a bonus to the generic similarity score that is inversely proportion to the distributional density of each of the two particular values. Moreover, this methodology can be extrapolated to multiple dimensions by calculating the distribution density for all dimensions that need to be considered.

Further, the invention in accordance with the present disclosure contemplates improvements to standard cosine similarity calculations. One such improvement is to calculate a semantic “entity-linking-value” for each incident report. This is a numeric score that assigns a higher value to those texts which contain information that is more likely to allow them to form links. Then along with the cosine similarity, include in the model the min and max variables of the “entity-linking-values” for each pair. These two additional variables are symmetric just like cosine similarity and when added to a machine-learning model will act to reduce probability when the texts do not contain valuable information for linking. The training set for the binary regression machine-learning model that predicts “entity-linking-value” can be created manually, by randomly sampling writeups and manually scoring them to create a training set, or can be created automatically directly from the user feedback loop by taking all of the individual text writeups from all pairs flagged as positively likely or definitively linked and setting the “entity-linking-value” of each of these writeups to 1, and randomly sampling a desired amount all other incidents and setting the entity-linking-value of these writeups to 0. The rationale is that manually flagged incidents must by necessity contain “quality” textual writeups to enable the user to link them to another incident.

A second approach to improving cosine similarity is achieved by performing the following method: create a Siamese deep learning model for each pair of texts, where the model trains on a binary training set where TRUE LINKS=1 and NON_LINKS=0; creating a dense vector representation by each side of the Siamese model; The final layer of the deep learning model, immediately connected to the Siamese layers, will be a weighted sum of the sum of the absolute values of the element-wise subtraction between the 2 vector representations from the Siamese neural networks, plus the element-wise addition between the 2 vector representations from the Siamese neural networks, which together create an augmented cosine similarity that will learn to magnify or lessen certain dimensions of the dense vectors which correspond to concepts present in the text that contain descriptions relevant to crime linking. This will prevent highly similar but low-quality texts to achieve a high score.

A third approach to improving cosine similarity involved calculating regional cosine similarities with learned hyperspheres. That method begins with representing each text as a TF-IDF weighted vector, where each vector is a sparse vector the length of all the distinct words (or n-grams) in the dataset, and equals 0 when the word (or n-gram) is not present in that text. Additionally, we require a numeric word embedding representation for every single term that is in our TF-IDF. These can be from pre-trained embeddings, or learned from the texts themselves. Note that the sparse vector representation of each text is not related to the word embeddings. The word embeddings are only used to find clusters of semantically similar terms when finding hyperspheres. The method must get a training set of texts where the positively linked pairs will have a y-value of 1 and the non-linked pairs will have a y-value of 0, the x-variable will be the regular cosine-similarity between the pair of texts and then save the prediction accuracy of a logistic regression model using this regular cosine-similarity as the sole predictor of y. Initialize this as the starting and current best score. Now we start with a random centerpoint in the word-embeddings space, along with a random radius value. We then compute the new cosine similarity of our texts using our same sparse vectors corresponding to the TF-IDF values associated with each word, except omitting all words, and corresponding elements of the sparse TF-IDF vectors whose word embeddings lie outside of the current hypersphere. Then we use this new cosine similarity as the sole predictor of y in our training set and see if it improves the prediction accuracy better than the current best score. If the prediction is better, save it as the current best score and also save the current centerpoint and radius as the current best hypersphere, as this hypersphere defines a more predictive set of words to compute cosine similarity from. Then try another quasi-random permutation of the centerpoint and radius values and again recompute just the cosine similarity from the reduced words and see if those values are more predictive than the previous values. If it is more predictive, we save the new values for the new hypersphere, else we keep the old values. There can be many variations to optimally searching for and finding the best values for one or more hyperspheres. This can be used to generate new features for the machine learning model. Note that the reason for using hypersphere shapes is to avoid overfitting, as they only require learning 2 parameters centerpoint and radius. Note that when finding multiple hyperspheres, the user can choose to allow them to overlap words used in previous hypersphere, or can remove words already used in previous hyperspheres.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, “a first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The invention is described above with reference to block and flow diagrams of systems, methods, apparatuses, and/or computer program products according to exemplary embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented a method for automatically linking associated incidents related to criminal activity. The disclosure is illustrated by example in the drawing figures, and throughout the written description. It should be understood that numerous variations are possible, while adhering to the inventive concept. Such variations are contemplated as being a part of the present disclosure.

What is claimed is:

1. A method for automatically linking related incidents related to criminal activity, comprising:
receiving at least two incident reports, each incident report containing a portion of raw text, a time indicator, and a location indicator,
wherein the portion of raw text contains information that relates to at least one item of information pertaining to a criminal event;
applying at least one set of rules to the portion of raw text,
wherein each set of rules is configured to determine whether one or more unique IDs is located in the portion of raw text from each of the at least two incident reports;
determining through the application of the at least one set of rules to the portion of raw text, whether one or more unique IDs is present in any of the at least two incident reports;
generating a vector for each pair of the at least two incident reports,
wherein the vector has a plurality of dimensions comparing the pair of incident reports;
applying one or more machine-learning algorithms to the vectors to determine a pairwise probability between each of the at least two incident reports; and
automatically linking pairs of incident reports when the pairwise probability is above a predetermined threshold amount.

2. The method of claim 1, further comprising the step of setting the pairwise probability of any known links between the at least two incident reports to 1.

3. The method of claim 1, wherein the information contains the time indicator and the location indicator.

4. The method of claim 1, wherein the one or more unique IDs are selected from the group consisting of: a full name, a physical characteristics, a ethnicity, a license plate, a driver's license number, an address, a credit card number, a unique customer ID, a customer loyalty number, a fingerprint, a retinal scan, a face map, a unique physical gait map, a keyboard and mouse usage map, DNA, a customer gift registry, a social security number, a email address, a phone number, an IP address, and an incident number.

5. The method of claim 2, wherein each of the plurality of dimensions is calculated, in part, by comparing a variable selected from the group consisting of: a time distance, a time-of-day difference, a geographic distance, a cosine similarity of the portion of raw text of the at least two incident reports, a gender description similarity, a ethnicity description similarity, an eye color description similarity, a hair color description similarity, a weekend indicator similarity, a height description similarity, a multiple suspect indicator, a weight description similarity, a vehicle description similarity, a maximum text quality score, a minimum text quality score, and an age description similarity between two incident reports.

6. The method of claim 5, wherein one machine-learning algorithm is applied and that algorithm employs a Siamese-trained pair of neural networks.

7. The method of claim 5, wherein one machine-learning algorithm is applied and that algorithm is a distance-based algorithm.

8. The method of claim 5, wherein one machine-learning algorithm is applied and that algorithm is a density-based algorithm.

9. The method of claim 5, further comprising:
submitting, by a human user, a new pairwise probability for a given pair of incident reports,
wherein the new pairwise probability supersedes the determined pairwise probability for the given pair of incident reports.

10. The method of claim 5, wherein one of the set of rules is configured to determine a full name from the portion of raw text comprises the steps of:
receiving a first list containing the most common given names in a particular geographical region of context;
receiving a second list containing the most common family names in the geographical region;
receiving a third list containing the most common in a language spoken in the geographical region;
culling the first list and the second list, by removing all names that overlap with entries in the third list;
generating a vector of words based on one of the at least two incident reports, where the vector retains the same order of words as listed in said incident report;
extracting from the vector, one or more first indices that contain words from the culled first list;
extracting from the vector, one or more second indices that contain words from the culled second list; and
detecting the presence of a first name immediately followed by a last name by subtracting 1 from the one or more second indices and comparing it to the one or more first indices.

11. The method of claim 5, wherein one of the set of rules is configured to determine a gender similarity score from the portion of raw text comprises the steps of:
generating a linear ordering having a plurality of groups based on one or more genders reported in the at least two incident reports,
wherein the linear ordering is based on a conditional probability of the likelihood of a positive link between any pair of the at least two incident reports,
wherein the conditional probability is based on different possible combinations of the one or more genders in each of the pair of the at least two incident reports;
receiving all of the items of information pertaining to one or more genders;
obtaining a first count of the items of information pertaining to males;
obtaining a second count of the items of information pertaining to females;
applying a correction factor to the first count and the second count; and
generating a score based on the corrected first count and the corrected second count for each of the plurality of groups.

12. The method of claim 11, further comprising:
creating a table of all of the linked incident reports; and
creating a training set for a machine-learning-enabled computer to process the table.

13. The method of claim 12, the step of creating a training set for a machine-learning-enabled computer to process the set, comprising:
providing a number of positive links between two of the at least two incident reports;
setting a first maximum threshold of an amount of positive links that will be used for training;
sampling the amount of positive links, where the amount is equal to or less than the first maximum threshold;
providing a number of quasipositive links between two of the incident reports;
setting a second maximum threshold of an amount of quasipositive links that will be used for training;
sampling the amount of quasipositive links, where the amount is equal to or less than the second maximum threshold;
sampling a number of negative links between two of the incident reports by generating two vectors of an incident ID that are an integer multiple of the amount of positive links;
combining the two vectors into a table having at least two columns, each column having a value;
combining the sampled positive links, the sampled quasipositive links, and the sampled negative links into the table having a column that indicates the probability of the link being valid within a given row; and
computing a distance vector of distance variables for each of the links within the table.

14. The method of claim 12, the step of creating a training set for a machine-learning-enabled computer to process the set, comprising:
providing a number of quasipositive links between two of the at least two incident reports;
setting a first maximum threshold of an amount of quasipositive links that will be used for training;
sampling the amount of quasipositive links, where the amount is equal to or less than the first maximum threshold; and
generating a number of negative links by randomly sampling two incidents from the at least two incident reports such that the randomly sampled incidents are individually present in at least one of the quasipositive links, but together are not a quasipositive link.

15. The method of claim 12, the step of providing, a number of quasipositive links between two of the at least two incident reports, comprising:
creating quasipositive links by providing the human user with a list of the highest pairwise probabilities, excluding positive links; and
allowing the human user to assign a second probability to the existing pairwise probability.

16. The method of claim 5, wherein one of the set of rules is for comparing an arbitrary discrete value, comprising the steps of:
providing a preselected list of a plurality of observed discrete states;
scraping the at least two incident reports for words or phrases that relate to each of the plurality of observed discrete states;
creating a binary indicator variable for each of the plurality of observed discrete states in each of the at least two incident reports where any of the plurality of discrete states are detected;
storing for the plurality of observed discrete states, a count corresponding to a sum of the total incidents of that detected observed state;
producing a first vector comprised of conditional probabilities of true state for each of the plurality of observed discrete states;
producing a second vector comprised of count-adjusted conditional probabilities,
wherein the count-adjusted conditional probabilities are created by adjusting the magnitude of the first vector inversely proportional to the count of each of the plurality of observed discrete states;
creating a scoring vector,
wherein the scoring vector is equal to the element-wise sum of all the second vectors from all of the observed discrete states, if more than one discrete state is observed, for a given incident, else equal to the single second vector;
creating a reduced scoring vector by multiplying the scoring vector by a constant reduction factor set between 1 and the inverse of the total discrete states detected in the given incident; and
obtaining a similarity score between two of the at least two incident reports by computing an inner product of the reduced scoring vectors associated with said two incident reports.

17. The method of claim 16, wherein the plurality of observed discrete states is based on the ethnicities prevalent in a selected geographical region.

18. The method of claim 16, wherein the step of “scraping the at least two incident reports for words or phrases that relate to each of the plurality of observed discrete states” is replaced by the step of: training a machine-learning model to detect the plurality of observed discrete states.

19. A method of creating synthetic positive links for use in a training dataset for training a model that takes a plurality of pairs, each comprised of two individual components, each pair as a single observation, along with a plurality of distance variables between each of the two individual components of the plurality of pairs, comprising:
selecting an amount of synthetic positive links to be created;
creating a synthetic subset of the training dataset having a plurality of rows of data,
wherein each row corresponds to one of the plurality of pairs;
creating a vector for the plurality of distance variables and similarity variables, where the length of each vector corresponds to the plurality of rows of data;
synthetically populating the plurality of distance variables and similarity variables by selecting a random value equivalent to a percentile from a random distribution having a probability density,
wherein the random distribution is within the range of 0 to 1, and
wherein the probability density monotonically decreases within that range;
extracting the percentile from all of the values for a given distance variable from the non-synthetic training set;
extracting 1 minus the percentile from all of the values for a given similarity variable from the non-synthetic training set;
repeating the previous steps for each distance variable; and
adding each of the synthetic positive links as a positive link in the training set.
